(19) United States
(12) Patent Application Publication
(10) Pub. No.: US 2026/0203219 A1
(43) Pub. Date: Jul. 16, 2026

(54) MINIMAL CACHE GENERATION FOR CLOUD SUBSTRATES

(71) Applicant: Salesforce, Inc., San Francisco, CA (US)

(72) Inventor: Kalyan Chakravarthy Thatikonda, San Francisco, CA (US)

(21) Appl. No.: 19/024,783

(22) Filed: Jan. 16, 2025

(51) Int. Cl. G06F 12/0802; G06F 12/14

(52) U.S. Cl. CPC G06F 12/0802; G06F 12/1416; G06F 2212/1052

(57) ABSTRACT

Systems, devices, and techniques are disclosed for minimal cache generation for cloud substrates. Records may be generated with security endpoint tools of a substrate of a cloud computing server system. Some of the records may include data identifying security violations found in applications of the substrate. A minimal cache including records may be generated based on the records including data identifying security violations. The records of the minimal cache may be smaller than the records generated with the endpoint security tools. The minimal cache may be sent to a second substrate. A compliance tracker of the second substrate may determine a security violation in an application of the second substrate based on the data identifying security violations from records of the minimal cache. The compliance tracker of the second substrate may perform an action to remediate the security violation in the application of the second substrate.

### BACKGROUND

Endpoint security tools may need to be configured on multiple cloud computing server substrates to pull compliance data from database systems. Database compliance cache distribution across cloud computing server substrates may be inefficient. Caches in a dynamic environment may need to be updated frequently to avoid stale data. Distributing a compliance cache across cloud computing server substrates may be expensive due to needing to deal with environments with across multiple different substrates where a replica of the compliance cache needs to be set up on each substrate to ensure consistency in the cache data across the multiple different substrates.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system suitable for minimal cache generation for cloud substrates according to an implementation of the disclosed subject matter.

FIG. 2 shows an example arrangement suitable for minimal cache generation for cloud substrates according to an implementation of the disclosed subject matter.

FIG. 3 shows an example arrangement suitable for minimal cache generation for cloud substrates according to an implementation of the disclosed subject matter.

FIG. 4 shows an example arrangement suitable for minimal cache generation for cloud substrates according to an implementation of the disclosed subject matter.

FIG. 5A shows an example arrangement suitable for minimal cache generation for cloud substrates according to an implementation of the disclosed subject matter.

FIG. 5B shows an example arrangement suitable for minimal cache generation for cloud substrates according to an implementation of the disclosed subject matter.

FIG. 6 shows an example procedure suitable for minimal cache generation for cloud substrates according to an implementation of the disclosed subject matter.

FIG. 7 shows an example procedure suitable for minimal cache generation for cloud substrates according to an implementation of the disclosed subject matter.

FIG. 8 shows a computer according to an implementation of the disclosed subject matter.

FIG. 9 shows a network configuration according to an implementation of the disclosed subject matter.

### DETAILED DESCRIPTION

Techniques disclosed herein enable minimal cache generation for cloud substrates, which may allow for the generation and distribution of a minimal cache across multiple cloud substrates. Endpoint security tools of a substrate of a cloud computing server system may generate records, some of which may include data identifying security violations found in applications of the substrate. A minimal cache may be generated including records that are based on the records that include data identifying security violations generated with the endpoint security tools. The records of the minimal cache may be smaller than the records generated with the endpoint security tools. Generating the minimal cache may include modifying data associated with the substrate in the records that include data identifying security violations to be general to additional substrates in the records generated for the minimal cache; and excluding columns of data of the records including data identifying security violations from the records generated for the minimal cache. The minimal cache may be generated by inputting the records including data identifying security violations to a machine learning system. The minimal cache may be sent to a second substrate. A compliance tracker of the second substrate may determine a security violation in an application of the second substrate based on the data identifying security violations from records of the minimal cache. The compliance tracker of the second substrate may perform an action to remediate the security violation in the application of the second substrate. Performing an action to remediate the security violation in the application of the second substrate may include modifying the operating system of the second substrate.

Endpoint security tools of a substrate of a cloud computing server system may generate records, some of which may include data identifying security violations found in applications of the substrate. A substrate of a cloud computing server system may be a division of the cloud computing server system that encompasses some number of physical computing devices. The entirety of a cloud computing server system may be considered to be a single substrate or may be divided into multiple substrates. The substrate of a cloud computing server system may have endpoint security tools that may perform scans on the substrate to identify security violations in applications that the substrate uses to provide services, including the operating systems and associated plug-ins and services running on any physical and virtual devices of the substrate. The substrate may include any suitable number of endpoint security tools, such as threat vulnerability and management (TVM) tools, endpoint management tools, patching and inventory tools, and risk monitoring tools. The security tools may perform scans on the substrate, and its constituent physical and virtual computing devices, and any suitable time and interval. The endpoint security tools may generate records based on their scans. The records may include any suitable data determined by the endpoint security tools during their scans. Some number of the records may include data the identifies security violations that the endpoint security tools determined found in applications of the substrate. The security violations may be, for example, vulnerabilities that have been identified in security advisories. The number of records that identify security violations may be less than the total number of records generated by the endpoint security tools, as the endpoint security tools may generate records that do not identify security violations.

A minimal cache may be generated including records that are based on the records that include data identifying security violations generated with the endpoint security tools. The records generated by the endpoint security tools may be used to generate a minimal cache using the records that identify security violations and not other records generated by the endpoint security tools. This may reduce the size of the size of the minimal cache when compared to a compliance cache that includes all of the records generated by the endpoint security tools including those that do not identify security violations. The records of the minimal cache may be smaller than the records generated with the endpoint security tools. A record generated for the minimal cache may be generated to be smaller than a record generated by the endpoint security tools by, for example, excluding columns of the record generated by the endpoint security tools from the record generated for the minimal cache. Data in the records generated with the endpoint security tools that is associated with the substrate of the cloud computing server system the was scanned to generate the records may be modified to be general to additional substrates when generating records for the minimal cache. This may allow the records of the minimal cache to be applicable across different substrates, including substrates on different cloud computing server systems, while still identifying the security violations found by the endpoint security tools.

The minimal cache may be generated by inputting the records including data identifying security violations to a machine learning system. The different endpoint security tools may generate data records that are in different forms and have different architectures. The machine learning system may be used to generate the records for the minimal cache by normalizing and enriching the records generated by the endpoint security tools using a custom machine learning data set. The custom machine learning dataset may use context-based immutable data aggregation techniques, as opposed to sum, count, average, max, min, or standard deviation data aggregation. Records generated by the endpoint security tools, for example, records that indicate the presence of a se may be divided into several categories which may then be populated with asset specific information based on a custom unique context for the applications common across all of the substrates to which the minimal cache will be sent. The output of the machine learning system may be records for the minimal cache that are smaller than the records generated by the endpoint security tools and have data that is specific to assets of the substrate that was scanned by the endpoint security tools replaced with data is that is general to assets across the various substrates to which the minimal cache will be sent. The records generated for the minimal cache may still include data on the security violations found in the scanned substrate of the cloud computing server system by the endpoint security tools. The minimal cache may be usable on any substrate that uses the same applications, for example, operating system, as the scanned substrate, as long as the applications are immutable. A compliance tracker of the substrate may enrich asset details of records in the minimal cache using a unique custom context-based object identifier for the digital assets identified in the records. The object identifiers may be used in determining the context of the digital assets across all endpoint security tools on the substrate.

The minimal cache may be sent to a second substrate. The second substrate may be a substrate of any suitable cloud computing server system, including, for example, the same cloud computing server system as the substrate that was scanned, or a different cloud computing server system. The minimal cache may be sent to the second substrate in any suitable manner, for example, using any suitable network connection. The minimal cache may be smaller than a database compliance cache that has all of the records generated by the endpoint security tools, allowing for the minimal cache to be sent more efficiently to multiple different substrates. The minimal cache may be sent to the second substrate at any suitable time or interval.

A compliance tracker of the second substrate may determine a security violation in an application of the second substrate based on the data identifying security violations from records of the minimal cache. The compliance tracker may be any suitable hardware and software of the second substrate that may be responsible for monitoring and ensuring security compliance of the second substrate. The compliance tracker may use records of the minimal cache to determine that the security violations identified in the records of the minimal cache are present in the second substrate. The second substrate may use the same immutable applications, for example, operating system, as the substrate that was scanned with the endpoint security tools. Any security violations that were found to exist in the applications of the substrate that was scanned with the endpoint security tools may also exist in the applications of the second substrate. For example, if the operating system running on the substrate that was scanned was found to have a security violation that requires the operating system to have a patch applied, the operating system running on the second substrate may have the same security violation and require the application of the same patch.

The compliance tracker of the second substrate may perform an action to remediate the security violation in the application of the second substrate. The compliance tracker may perform any suitable actions needed to remedy the security violations present in the applications of the second substrate. This may include, for example modifying applications of the second substrate, such as an operating system, by applying patches, hotfixes, or other updates or changes. The compliance tracker of the second substrate may remediate any security violations identified in the records of the minimal cache. Similarly, any other substrate which receives the minimal cache may include a compliance tracker that may identify and remedy security violations identified in the minimal cache. The minimal cache may be usable on any substrate without those substrates needing to have their own endpoint security tools deployed. This may reduce the number of scans performed by endpoint security tools across the substrates to which the minimal cache is sent, reducing computational overhead on those substrates and the cloud computing server systems of which they are a part.

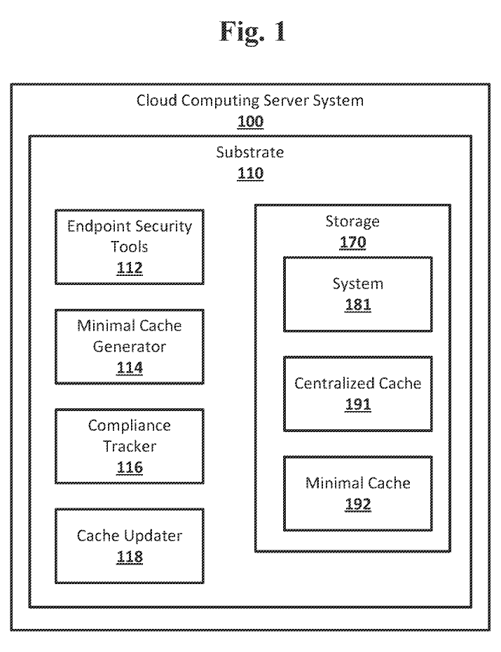

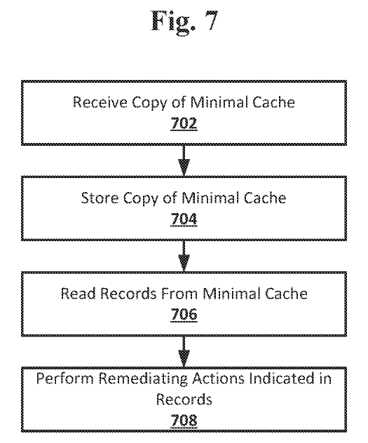

FIG. 1 shows an example system suitable for minimal cache generation for cloud substrates according to an implementation of the disclosed subject matter. A cloud computing server system 100 may be a server system that may include computing devices such as, for example, the computer 20 as described in FIG. 8, or components thereof. The cloud computing server system 100 may include any number computing devices, each of which may include any suitable combination of central processing units (CPUs), graphical processing units (GPUs), and tensor processing units (TPUs). The cloud computing server system 100 may be distributed over any geographic area, and may, for example, include geographically disparate computing devices connected through any suitable network connections. The cloud computing server system 100 may be a multi-tenanted server system.

The cloud computing server system 100 may include a substrate 110. The substrate 110 may be any suitable combination of hardware and software on the cloud computing server system 100 that may be considered to be a division of the cloud computing server system 100 that encompasses some number of physical computing devices of the cloud computing server system 100 and software that allows the substrate 110 to operate. The substrate 110 may encompass all of the cloud computing server system 100, or the cloud computing server system 100 may include other substrates along with the substrate 110.

The substrate 110 may include endpoint security tools 112, minimal cache generator 114, compliance tracker 116, and cache updater 118. The endpoint security tools 112 may be any suitable combination of hardware and software for implementing endpoint security tools that may run on the substrate 110 and may scan applications of the substrate 110, including, for example, any operating systems in use on physical computing devices and virtual computing devices of the substrate 110, for security violations. The endpoint security tools 112 may, for example, scan system 181 for security violations. The endpoint security tools 112 may include any number of different endpoint security tools, all of which may perform any suitable scans and generate scan records. The endpoint security tools 112 may perform scans at any suitable times and intervals. The scan records generated by the endpoint security tools 112 may be stored in a centralized cache 191.

The minimal cache generator 114 may be any suitable combination of hardware and software for implementing a machine learning system that may be used to generate a minimal cache, such as minimal cache 192, from scan records generated by the endpoint security tools 112. The minimal cache generator 114 may, for example, normalize and enrich the scan records generated by the endpoint security tools 112 using a custom machine learning data set. The custom machine learning dataset may use context-based immutable data aggregation techniques, as opposed to sum, count, average, max, min, or standard deviation data aggregation. Records generated by the endpoint security tools 112, for example, records that indicate the presence of a security violation, may be divided into several categories which may then be populated with asset specific information based on a custom unique context for the applications common across all of the substrates to which the minimal cache 192 will be sent. The output of the machine learning system of the minimal cache generator 114 may be records for the minimal cache 192 that are smaller than the scan records generated by the endpoint security tools 112 and have data that is specific to assets of the substrate 110 that was scanned by the endpoint security tools 112 replaced with data is that is general to assets across the various substrates to which the minimal cache 192 will be sent. The records generated for the minimal cache 192 by the minimal cache generator 114 may still include data on the security violations found in the substrate 110 of the cloud computing server system 100 by the endpoint security tools 112. The minimal cache generator 114 may generate records for the minimal cache 192 whenever any of the endpoint security tools 112 generates new scan records by scanning the system 181, as those scan records may be input to the minimal cache generator 114.

The compliance tracker 116 may be any suitable combination of hardware and software for implementing a machine learning system that may be used to track the security compliance of the substrate 110, including the system 181 and remedy security violations. The compliance tracker 116 may, for example, use scan records generated by the endpoint security tolls 112 to determine the security compliance of the substrate 110 based on security violations identified in the scan records. The compliance tracker 116 may also perform remediating actions to remedy any security violations identified in the scan records, for example, applying patches, hotfixes, upgrades, or settings and configuration changes to the system 181. The scan records that identify security violations may also include an identification of the remediating action that should be taken by the compliance tracker 116. The compliance tracker 116 may also enrich asset details of records for the minimal cache 192 using a unique custom context-based object identifier for the digital assets identified in the records. The object identifiers may be used in determining the context of the digital assets across all endpoint security tools 112 on the substrate 110.

The cache updater 114 may be any suitable combination of hardware and software for updating the centralized cache 191 and the minimal cache 192. As the endpoint security tools 112 scan the system 181 and generate scan records, the cache updater 118 may update the centralized cache 191 with the newly generated scan records. As scan records are processed by the minimal cache generator 115 and compliance tracker 116 to generate records for the minimal cache 192, the cache updater 118 may update the minimal cache 192 with the newly generated records.

The substrate 110 of the cloud computing server system 100 may include a storage 170. The storage 170 may be any suitable combination of hardware and software for storing data on any suitable physical storage mediums that may be part of or accessible to the cloud computing server system 100, including local storage and storage accessible over wired or wireless connections including network connections. The storage 170 may store the system 181, the centralized cache 191, and the minimal cache 192. The system 181 may include any operating systems that may run on the substrate 110 that may be scanned by the endpoint security tools 112. The operating systems of the system 181 may be immutable operating systems. An immutable operating system may not change during use of the operating system, and every installation of a specific version of an immutable operating system may be identical to every other installation of the that specific version of the immutable operating system. A current version of the immutable operating systems of the system 181 may be updated by being replaced in the system 181 with a new version of the immutable operating system that includes the desired updates rather than applying the update to the current version of the immutable operating system of the system 181. The system 181 may also include non-operating system applications that may be considered part of the system of the substrate 110. The centralized cache 191 may be a cache of scan records generated by the endpoint security tools 112. The minimal cache 192 may be a cache of records generated by the minimal cache generator 114 based on the scan records generated by the endpoint security tools 112. The minimal cache 112 may include fewer records than the centralized cache 191, and the records of the minimal cache 192 may be smaller than the records of the centralized cache 191.

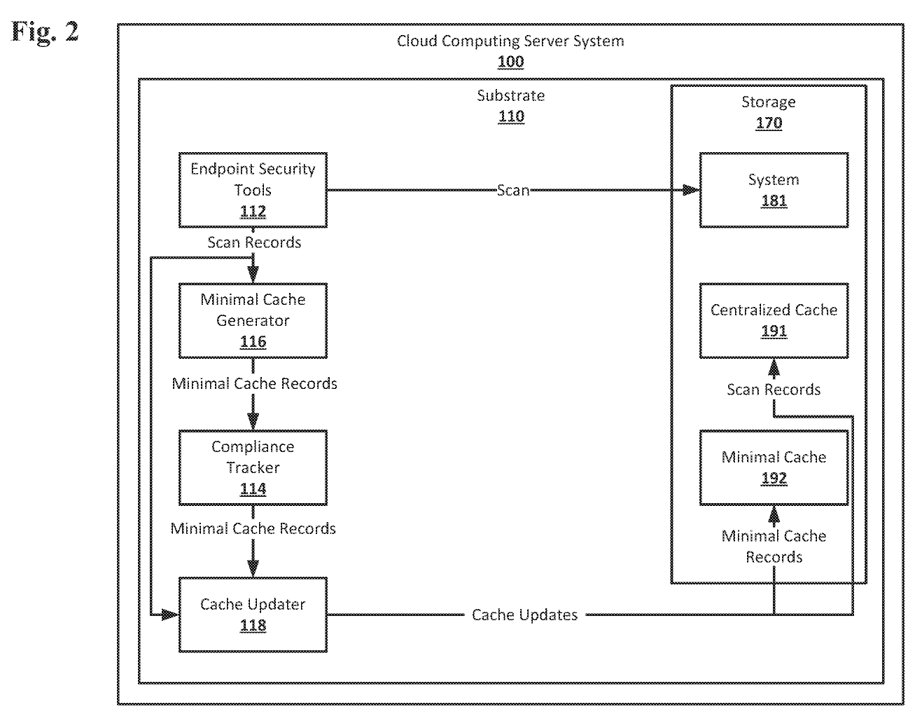

FIG. 2 shows an example arrangement suitable for minimal cache generation for cloud substrates according to an implementation of the disclosed subject matter. The endpoint security tools 112 may scan the system 181 on the substrate 110. The scans may be performed at any suitable times and intervals, and different ones of the endpoint security tools 112 may scan the system 181 at different times and on different schedules. The endpoint security tools 112 may scan the system 181 to determine if there are any security violations in the system 181. Different ones of the endpoint security tools 112 may scan for different security violations, and may, for example, use different public repositories of security notices, such as common vulnerabilities and exposures (CVEs), when scanning the system 181 for security violations. The endpoint security tools 112 may generate scan records that may include the results of the scan performed on the system 181. Some of the scan records generated by the endpoint security tools 112 may indicate the presence of and identify specific security violations in the system 181, while other records may indicate the absence of and identify other specific security violations in the system 181.

The minimal cache generator 116 may receive the scan records generated by the endpoint security tools 112 and generate records for the minimal cache 192. The minimal cache generator 116, may, for example, normalize and enrich the scan records generated by the endpoint security tools 112 using a custom machine learning data set. The custom machine learning dataset may use context-based immutable data aggregation techniques, as opposed to sum, count, average, max, min, or standard deviation data aggregation. Scan records, for example, scan records that indicate the presence of a security violation, may be divided into several categories which may then be populated with asset specific information based on a custom unique context for the applications common across all of the substrates to which the minimal cache 192 will be sent. The output of the machine learning system of the minimal cache generator 114 may be records for the minimal cache 192 that are smaller than the scan records generated by the endpoint security tools 112 and have data that is specific to assets of the substrate 110 that was scanned by the endpoint security tools 112 replaced with data is that is general to assets across the various substrates to which the minimal cache 192 will be sent. The minimal cache generator 116 may only generate records for the minimal cache 192 using scan records that indicate the presence of a security violation. Scan records that indicate the absence of a security violation may not be used to generate records for the minimal cache 192. This may allow the minimal cache 192 to have fewer records than the centralized cache 191.

The compliance tracker 114 may receive records generated by the minimal cache generator 116 and may enrich asset details of records for the minimal cache 192 using a unique custom context-based object identifier for the digital assets identified in the records. The object identifiers may be used in determining the context of the digital assets across all endpoint security tools 112 on the substrate 110.

The cache updater 118 may receive the scan records from the endpoint security tools 112 and the minimal cache records from the compliance tracker 114. The cache updater 118 may update the centralized cache 191 with the scan records, which may include all of the records generated by the endpoint security tools 112 including those that indicate the absence of a security violation. The cache updater 118 may update the minimal cache 192 with the minimal cache records, which may only include records that indicate the presence of a security violation.

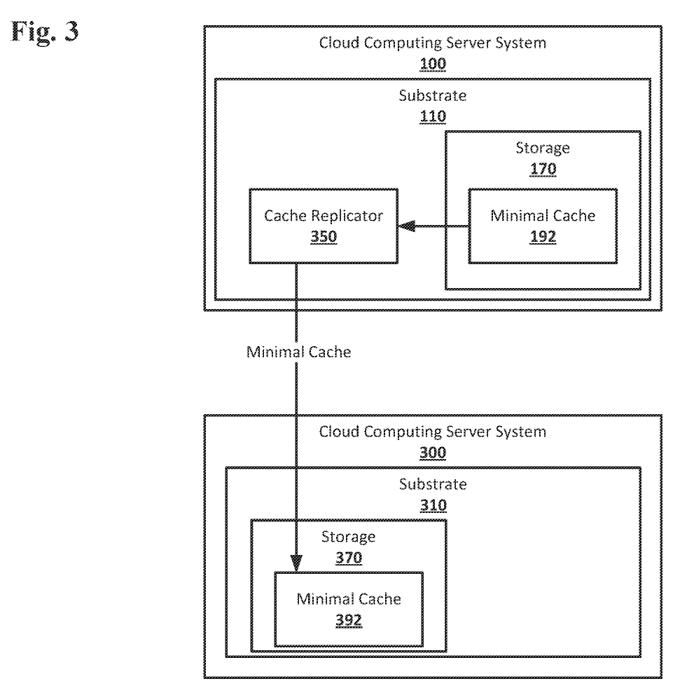

FIG. 3 shows an example arrangement suitable for minimal cache generation for cloud substrates according to an implementation of the disclosed subject matter. The substrate 110 may include a cache replicator 350. The cache replicator 350 may be any suitable combination of hardware and software that may send a copy of the minimal cache 192 to other substrates. The cache replicator 350 may package copies of the minimal cache 192 for sending in any suitable manner and send the copies of the minimal cache 192 using any suitable wired or wireless network connection to any substrate that may have a system that uses the same immutable operating systems and applications as the substrate 110. The cache replicator 350 may, for example, send a copy of the minimal cache 192 to a substrate 310 of a cloud computing server system 300. The cache replicator 350 may send copies of the minimal cache 192 to any suitable number of other substrates at any suitable times and intervals, such as, for example, whenever the minimal cache 192 is updated with new records generated by the minimal cache generator 116.

A cloud computing serve system 300 may be a server system that may include computing devices such as, for example, the computer 20 as described in FIG. 8, or components thereof. The cloud computing server system 100 may include any number computing devices, each of which may include any suitable combination of central processing units (CPUs), graphical processing units (GPUs), and tensor processing units (TPUs). The cloud computing server system 100 may be distributed over any geographic area, and may, for example, include geographically disparate computing devices connected through any suitable network connections. The cloud computing server system 300 may be a multi-tenanted server system.

The cloud computing server system 300 may include the substrate 310. The substrate 310 may be any suitable combination of hardware and software on the cloud computing server system 300 that may be considered to be a division of the cloud computing server system 300 that encompasses some number of physical computing devices of the cloud computing server system 300 and software that allows the substrate 310 to operate. The substrate 310 may encompass all of the cloud computing server system 300, or the cloud computing server system 300 may include other substrates along with the substrate 310. The substrate 310 may include a system that may use the same immutable operating systems and applications as the system 181 and use the same versions of these immutable operating systems and applications as the system 181 at the time of the latest scan of the system 181 by the endpoint security tools 112. This may ensure that security violations that are present in the system 181 are also present in the system of the substrate 310, and security violations that are absent in the system 181 are also absent in the system of the substrate 310, as the system 181 and the system of the substrate 310 may be identical due to including the same versions of the same immutable operating systems and applications.

The substrate 310 may receive the copy of the minimal cache 192 from the cache replicator 350 and store the copy of the minimal cache 192 as the minimal cache 392 in a storage 370 of the substrate 310. The substrate 310 may not store a centralized cache similar to the centralized cache 191, as the substrate 310 may use the minimal cache 392, as replicated from the minimal cache 192, to determine security violations present in the system of the substrate 310.

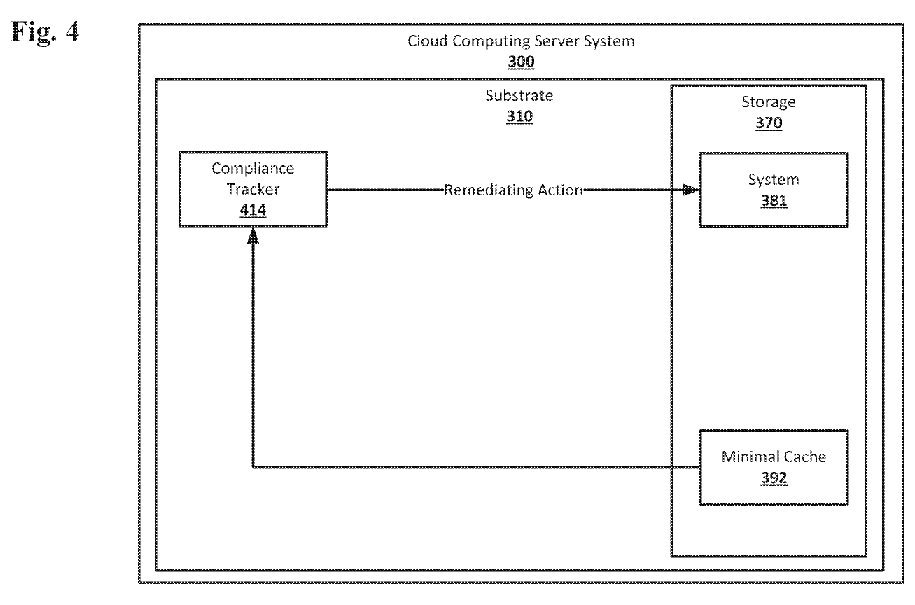

FIG. 4 shows an example arrangement suitable for minimal cache generation for cloud substrates according to an implementation of the disclosed subject matter. A compliance tracker 414 of the substrate 310 may use the minimal cache 392 to determine the existence of security violations in the system 381 and perform appropriate remediating actions. The records of the minimal cache 392 may include indications of security violations that were found in the system 181. The system 381 may be identical to the system 181 at the time the system 181 was scanned by the endpoint security tools 112, as both may include the same versions of the same immutable operating systems. Any security violations found by the endpoint security tools 112 in the system 181 may thus also be present in the system 381. The compliance tracker 414 may read the records from the minimal cache 392 and determine that the security violations indicated in the records of the minimal cache 392 are also present in the system 381. This determination may be made without the use of any endpoint security tools on the substrate 310 and without any other scanning of the system 381. The compliance tracker 414 may take remediating actions as indicated by the records in minimal cache 392. A record of the minimal cache 392 may include the remediating actions needed to remedy the security violation identified in the record. The remediating actions performed by the compliance tracker 414 may include patching, hot fixing, or upgrading the system 381, including the immutable operating systems and applications, through any suitable process used for upgrading immutable software. For example, the compliance tracker 414 may build a new version of an immutable operating system of the system 381 which may then be used to replace the currently existing version of the immutable operating system in the system 381. The new version built by the compliance tracker 414 may including any suitable upgrades, patches, and fixes for security violations identified by the minimal cache 392, so that the new version of the immutable operating system may not have the security violations that the version of the immutable operating system being replaced does. In this manner the compliance tracker 414 may remediate security violations in the system 381 that are identified in the records of the minimal cache 392. Remediating the security violations identified in the records of the minimal cache 392 may result in the system 381, after remediation, being identical to the system 181 after the system 181 has remediating actions performed based on security violations identified in the records of the minimal cache 192.

Any substrate that receives a copy of the minimal cache 192 may similarly use a compliance tracker to perform remediating actions on the substrate's system, as any substrate that receives a copy of the minimal cache 192 may have a system identical to the system 181. This may allow multiple substrates to have security violations remediating, ensuring security compliance, without the use of endpoint security tools on those substrates and without requiring a full cache such as the centralized cache 191.

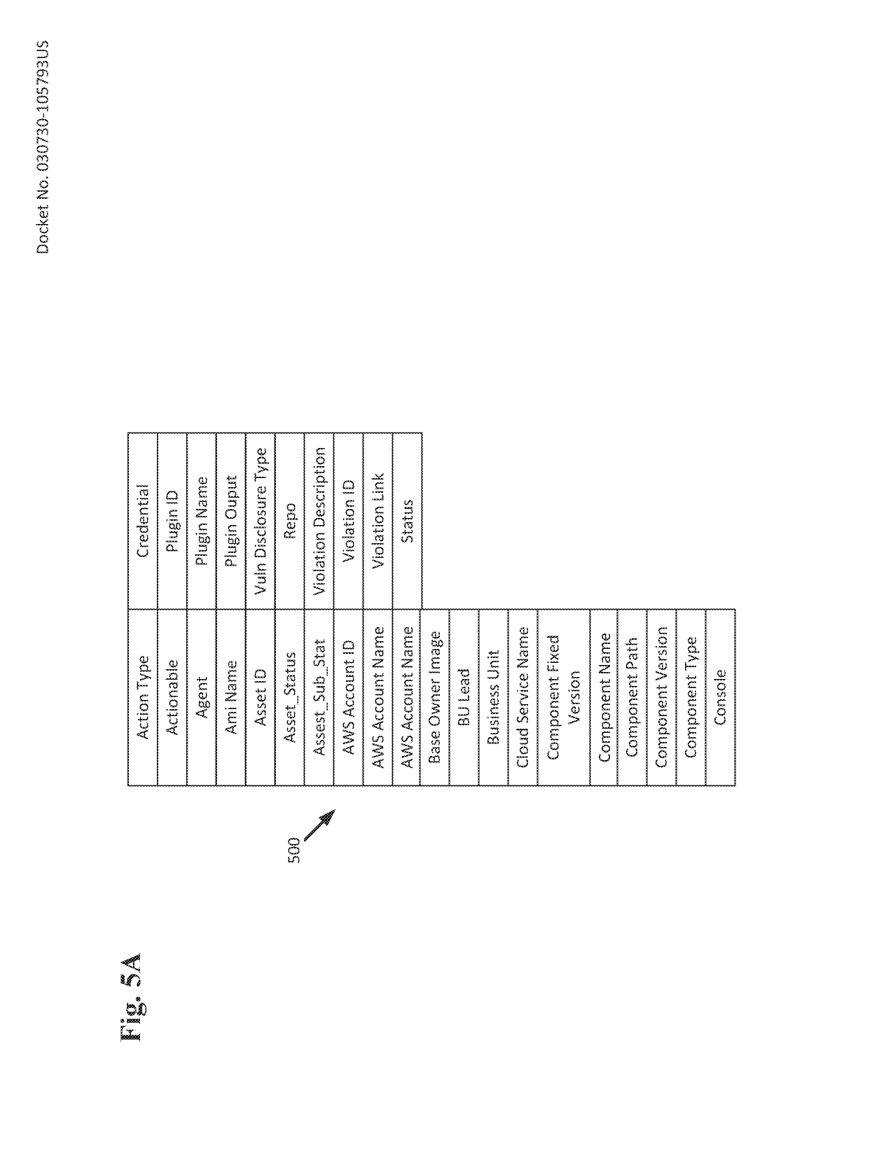

FIG. 5A shows an example arrangement suitable for minimal cache generation for cloud substrates according to an implementation of the disclosed subject matter. Scan record structure 500 may be the structure of a scan record generated by one of the endpoint security tools 112 after scanning the system 181. The scan record structure 500 may include fields such as action type, actionable, agent, ami name, asset ID, asset status, asset sub status, AWS account ID, AWS account name, base owner image, BU lead, business unit, cloud service name, component fixed version, component name, component path, component version, component type, console, credential, plugin ID, plugin name, plugin output, vulnerability disclosure type, repo, violation description, violation ID, violation link, and status. Different endpoint security tools 112 may have different scan record structures. For example, another of the endpoint security tools 112 may have a scan record structure that includes fields such as application, asset ID, version, hostname, application groups, category, install date, last used, last updated, last username, last file name, last file hash, suspicious activity (application), file path, build number, device type, CPU architecture, MAC address, manufacturer, network prefix, OS version, platform, vendor, and tags.

FIG. 5B shows an example arrangement suitable for minimal cache generation for cloud substrates according to an implementation of the disclosed subject matter. Minimal cache record 550 may be an example of a record for the minimal cache 192, as generated from scan records such as those that use the scan record structure 500. The minimal cache record 550 may be smaller than a scan record, as the structure of the minimal cache record 550 may include fewer fields than the scan record structure 500. The minimal cache record 550 may include fields added by, for example, the minimal cache generator 114 and the compliance tracker 116, such as the unique custom object identifier, compliance identifier, and security endpoint unique identifier. The minimal cache record 550 may include an identification of a security violation and the recommended remediating actions that may be taken to restore security compliance. Other fields of the minimal cache record 550 may be asset owner, application information, plugin details, operating system build source, operating system version, operating system flavor, violation details, and compliance action recommendations. The minimal cache record 550 may be usable by any compliance tracker on any substrate that has a system identical to the system that was scanned to generate the scan records used to generate the minimal cache record 550.

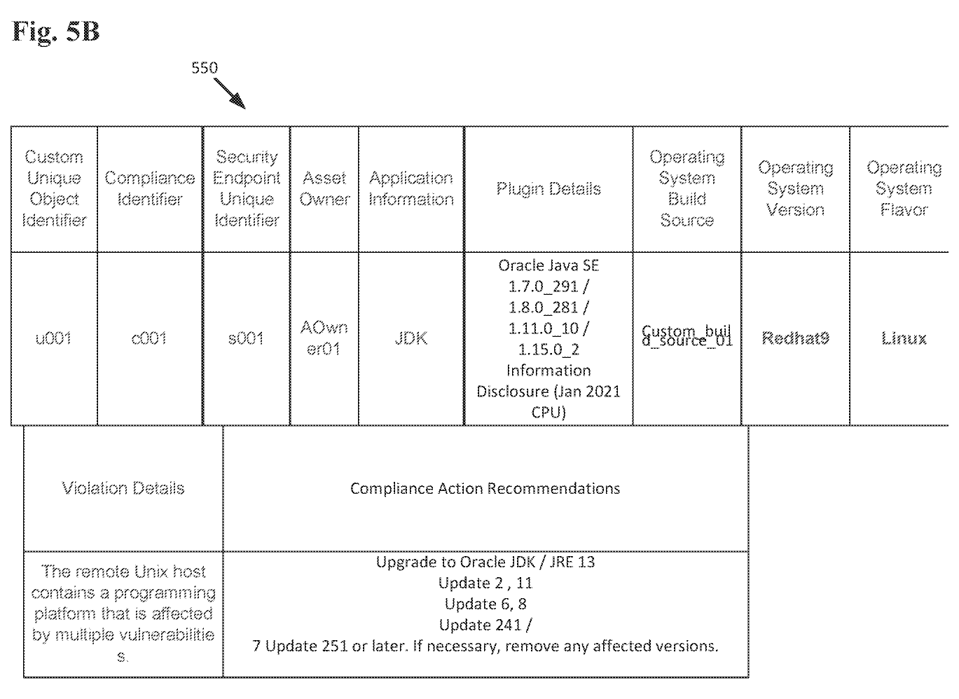

FIG. 6 shows an example procedure suitable for minimal cache generation for cloud substrates according to an implementation of the disclosed subject matter. At 602, scan records may be generated with endpoint security tools. For example, the endpoint security tools 112 may perform scans on the system 181 of the substrate 110 and generate scan records that indicate the results of the scans. Different ones of the endpoint security tools 112 may generate scan records using their own record structures, which may different between different endpoint security tools. Some of the scan records generated by the endpoint security tools 112 may indicate the presence of specific security violations in the system 181 while other scan records generated by the endpoint security tools 112 may indicate the absence of specific security violations in the system 181.

At 604, minimal cache records may be generated from scan records. For example, the scan records generated by the endpoint security tools 112, in addition to being stored as part of the centralized cache 191, may be used in the generation of records for the minimal cache 192. The scan records may be input to the minimal cache generator 114 which may, for example, use a machine learning system to generate minimal cache records by normalizing and enriching the scan records using a custom machine learning data set. The custom machine learning dataset may use context-based immutable data aggregation techniques, as opposed to sum, count, average, max, min, or standard deviation data aggregation. The compliance tracker 116 may also enrich asset details of records for the minimal cache 192 using a unique custom context-based object identifier for the digital assets identified in the records. The object identifiers may be used in determining the context of the digital assets across all endpoint security tools 112 on the substrate 110. The records generated for the minimal cache 192 may be smaller and fewer in number than the scan records generated by the endpoint security tools 112, and may, for example, only include records that indicate the presence of security violation and not records that indicate the absence of a security violation.

At 606, the minimal cache records may be stored in a minimal cache. For example, the minimal cache records, as generated by the minimal cache generator 114 and the compliance tracker 116, may be stored in the minimal cache 192 of the storage 170 on the substrate 110.

At 608, copies of the minimal cache may be sent to other substrates. For example, a copy of the minimal cache 192 may be sent by the cache replicator 350 to the substrate 310, where the copy of the minimal cache 192 may be stored as the minimal cache 392. A copy of the minimal cache 192 may be sent to any substrate that may include a system that is identical tot the system 181, for example, using the same versions of the same immutable operating systems and applications.

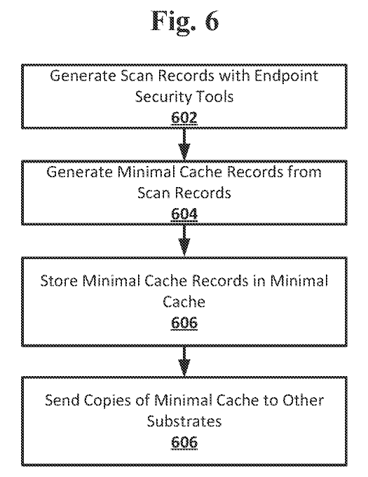

FIG. 7 shows an example procedure suitable for minimal cache generation for cloud substrates according to an implementation of the disclosed subject matter. At 702, a copy of a minimal cache may be received. For example, the substrate 310 may receive a copy of the minimal cache 192 from the cache replicator 350 of the substrate 110. The copy of the minimal cache may be received at any suitable time and interval over any suitable form of electronic communication, including wired and wireless network connections.

At 704, a copy of the minimal cache may be stored. For example, the copy of the minimal cache 192 received by the substrate 310 may be stored as the minimal cache 392 in the storage 370.

At 706, records may be read from the minimal cache. For example, the compliance tracker 414 may read the records from the minimal cache 392. The compliance tracker 414 may read the records to determine which security violations are present in the system 381, as they may be the same as the security violations that are present in the system 181 as indicated by the records in the minimal cache 192 and its copy the minimal cache 392. This may allow for the identification of security violations in the system 381 without scanning the system 381.

At 708, remediating actions indicated in the records may be performed. For example, the compliance tracker 414 may perform remediating actions on the system 381 based on the remediating actions indicated in the records of the minimal cache 392. These may be the same remediating actions that the compliance tracker 114 performs on the system 181 to remedy the security violations identified during the scanning of the system 181 by the endpoint security tools 112. This may allow the system 381 to have security violations remediated, brining the system 381 into security compliance, without the deployment of endpoint security tools on the substrate 310.

Implementations of the presently disclosed subject matter may be implemented in and used with a variety of components and network architectures. FIG. 8 is an example computer 20 suitable for implementing implementations of the presently disclosed subject matter. As discussed in further detail herein, the computer 20 may be a single computer in a network of multiple computers. As shown in FIG. 8, computer 20 may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 may enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

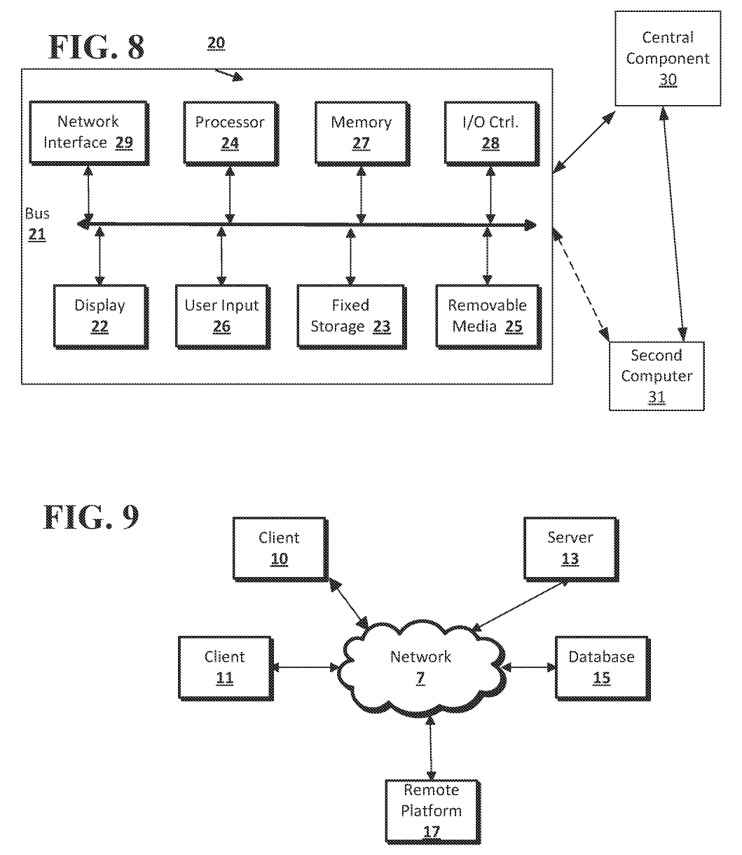

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 9.

Many other devices or components (not shown) may be connected in a similar manner (e.g., document scanners, digital cameras and so on). Conversely, all of the components shown in FIG. 8 need not be present to practice the present disclosure. The components can be interconnected in different ways from that shown. The operation of a computer such as that shown in FIG. 8 is readily known in the art and is not discussed in detail in this application. Code to implement the present disclosure can be stored in computer-readable storage media such as one or more of the memory 27, fixed storage 23, removable media 25, or on a remote storage location.

FIG. 9 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special- purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for the purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
generating, with one or more security endpoint tools of a substrate of a cloud computing server system, records, wherein one or more of the records comprise data identifying security violations found in applications of the substrate, and wherein the one or more of the records are less than all of the records;
generating a minimal cache comprising records based on the one or more records comprising data identifying security violations generated with the endpoint security tools, wherein the records of the minimal cache are smaller than the records generated with the endpoint security tools;
sending the minimal cache to a second substrate;
determining, by a compliance tracker of the second substrate, a security violation in an application of the second substrate based on the data identifying security violations from records of the minimal cache; and
performing, by the compliance tracker of the second substrate, at least one action to remediate the security violation in the application of the second substrate.

2. The computer-implemented method of claim 1, wherein generating a minimal cache comprising records based on the one or more records comprising data identifying security violations generated with the endpoint security tools, wherein the records of the minimal cache are smaller than the records generated with the endpoint security tools further comprises:
modifying data associated with the substrate in the one or more records comprising data identifying security violations to be general to additional substrates in the records generated for the minimal cache; and
excluding one or more fields of data of the one or more records comprising data identifying security violations from the records generated for the minimal cache.

3. The computer-implemented method of claim 1, wherein generating a minimal cache comprising records based on the one or more records comprising data identifying security violations generated with the endpoint security tools, wherein the records of the minimal cache are smaller than the records generated with the endpoint security tools further comprises inputting the one or more records comprising data identifying security violations to a machine learning system.

4. The computer-implemented method of claim 1, wherein performing at least one action to remediate the security violation in the application of the second substrate comprises updating an operating system of the second substrate.

5. The computer-implemented method of claim 1, wherein the applications of the substrate comprise at least one immutable operating system and wherein the applications of the second substrate comprise the same at least one immutable operating system of the first substrate.

6. The computer-implemented method of claim 1, wherein the records of the minimal cache further comprise indications of remediating actions to be performed to remediate the security violations identified in the records of the minimal cache.

7. The computer-implemented method of claim 1, wherein the security violations are determined in the application of the second substrate without endpoint security tools on the second substrate.

8. A computer-implemented system comprising:
a storage;
a processor that generates, with one or more security endpoint tools of a substrate of a cloud computing server system, records, wherein one or more of the records comprise data identifying security violations found in applications of the substrate, and wherein the one or more of the records are less than all of the records,
generates a minimal cache comprising records based on the one or more records comprising data identifying security violations generated with the endpoint security tools, wherein the records of the minimal cache are smaller than the records generated with the endpoint security tools,
sends the minimal cache to a second substrate; and
a second processor that determines, with a compliance tracker of the second substrate, a security violation in an application of the second substrate based on the data identifying security violations from records of the minimal cache, and
performs, with the compliance tracker of the second substrate, at least one action to remediate the security violation in the application of the second substrate.

9. The computer-implemented system of claim 8, the processor wherein generates a minimal cache comprising records based on the one or more records comprising data identifying security violations generated with the endpoint security tools, wherein the records of the minimal cache are smaller than the records generated with the endpoint security tools by:
modifying data associated with the substrate in the one or more records comprising data identifying security violations to be general to additional substrates in the records generated for the minimal cache, and
excluding one or more fields of data of the one or more records comprising data identifying security violations from the records generated for the minimal cache.

10. The computer-implemented system of claim 8, wherein the processor generates a minimal cache comprising records based on the one or more records comprising data identifying security violations generated with the endpoint security tools, wherein the records of the minimal cache are smaller than the records generated with the endpoint security tools, by inputting the one or more records comprising data identifying security violations to a machine learning system.

11. The computer-implemented system of claim 8, wherein the processor performs at least one action to remediate the security violation in the application of the second substrate by updating an operating system of the second substrate.

12. The computer-implemented system of claim 8, wherein the applications of the substrate comprise at least one immutable operating system and wherein the applications of the second substrate comprise the same at least one immutable operating system of the first substrate.

13. The computer-implemented system of claim 8, wherein the records of the minimal cache further comprise indications of remediating actions to be performed to remediate the security violations identified in the records of the minimal cache.

14. The computer-implemented system of claim 8, wherein the security violations are determined in the application of the second substrate without endpoint security tools on the second substrate.

15. A system comprising: one or more computers and one or more non-transitory storage devices storing instructions, when executed which are operable by the one or more computers, to cause the one or more computers to perform operations comprising:
generating, with one or more security endpoint tools of a substrate of a cloud computing server system, records, wherein one or more of the records comprise data identifying security violations found in applications of the substrate, and wherein the one or more of the records are less than all of the records;
generating a minimal cache comprising records based on the one or more records comprising data identifying security violations generated with the endpoint security tools, wherein the records of the minimal cache are smaller than the records generated with the endpoint security tools;
sending the minimal cache to a second substrate;
determining, by a compliance tracker of the second substrate, a security violation in an application of the second substrate based on the data identifying security violations from records of the minimal cache; and
performing, by the compliance tracker of the second substrate, at least one action to remediate the security violation in the application of the second substrate.

16. The system of claim 15, wherein the instructions which are operable, when executed by the one or more computers, to cause the one or more computers to perform operations comprising generating a minimal cache comprising records based on the one or more records comprising data identifying security violations generated with the endpoint security tools, wherein the records of the minimal cache are smaller than the records generated with the endpoint security tools further cause the one or more computers to perform operations comprising:
modifying data associated with the substrate in the one or more records comprising data identifying security violations to be general to additional substrates in the records generated for the minimal cache; and
excluding one or more fields of data of the one or more records comprising data identifying security violations from the records generated for the minimal cache.

17. The system of claim 15, wherein the instructions which are operable, when executed by the one or more computers, to cause the one or more computers to perform operations comprising generating a minimal cache comprising records based on the one or more records comprising data identifying security violations generated with the endpoint security tools, wherein the records of the minimal cache are smaller than the records generated with the endpoint security tools further cause the one or more computers to perform operations comprising inputting the one or more records comprising data identifying security violations to a machine learning system.

18. The system of claim 15, wherein the instructions which are operable, when executed by the one or more computers, to cause the one or more computers to perform operations comprising performing at least one action to remediate the security violation in the application of the second substrate further cause the one or more computers to perform operations comprising updating an operating system of the second substrate.

19. The system of claim 18, wherein the applications of the substrate comprise at least one immutable operating system and wherein the applications of the second substrate comprise the same at least one immutable operating system of the first substrate.

20. The system of claim 15, wherein the records of the minimal cache further comprise indications of remediating actions to be performed to remediate the security violations identified in the records of the minimal cache.
